(19) United States
(12) Patent Application Publication
(10) Pub. No.: US 2026/0248164 A1
(43) Pub. Date: Aug. 27, 2026

(54) SYSTEM AND METHOD FOR PRODUCING A PASTY FOOD

(71) Applicant: Challenger Industrial Solutions GmbH, Bad Karlshafen (DE)

(72) Inventor: Numan ALJUNEIDI, Amman (JO)

(73) Assignee: Challenger Industrial Solutions GmbH, Bad Karlshafen (DE)

(21) Appl. No.: 18/870,658

(22) PCT Filed: Jun. 1, 2023
(86) PCT No.: PCT/EP2023/064633

§ 371 Date: Nov. 30, 2024

(30) Foreign Application Priority Data
Jun. 1, 2022 (EP) 22176816.1

(51) Int. Cl. A23L 11/00; B01F 23/50; B01F 23/53; B01F 33/81; B01F 35/221; B01F 35/90; B01F 35/92; B01F 101/09

(52) U.S. Cl. CPC A23L 11/05; B01F 23/511; B01F 23/53; B01F 23/565; B01F 23/59; B01F 33/811; B01F 35/2215; B01F 35/92; B01F 2035/99; B01F 2101/09

(57) ABSTRACT

A system for producing a pasty food from a starch-containing and/or protein-containing basic ingredient, at least a first supplementary ingredient and water uses a vessel and a mixing device. The vessel allows the basic ingredient to be processed into a pasty food base, and the mixing device allows the food to be produced from the first supplementary ingredient and the pasty food base. The system is and/or can be brought into operative connection with an inert gas, by which an inert gas can be provided, wherein the vessel volume, the mixing volume and all pipe volumes of the pipeline system are and/or can be gas-conductingly connected to the inert gas source in such a way that the volumes can be filled and/or topped up with the inert gas, such that it is possible to prevent the food base and the food from coming into contact with oxygen and/or ambient air.

### CROSS-REFERENCE TO RELATED APPLICATION

This application is a national stage application, filed under 35 U.S.C. § 371, of International Patent Application PCT/EP2023/064633, filed on Jun. 1, 2023, which claims the benefit of European Patent Application EP 22176816.1, filed on Jun. 1, 2022.

### BACKGROUND

In the processing and production of food, measures to establish and maintain the necessary hygiene and to improve the shelf life of a food are of paramount importance. This is a challenge in particular when producing pasty food, as a large part of the natural preservation mechanisms are lost in the course of processing. In particular, the cell walls of the basic ingredients are broken down. This is how the pasty foods retain some of their nutritional value, as the nutrients contained in the cells become more readily available; however, this improved availability of nutrients also benefits the micro-organisms that are involved in putrefaction processes, such as bacteria and/or fungi. For this reason, pasty foods often have a very limited shelf life if no preservation measures are taken.

In the field of food processing, a variety of preservation measures are known. For example, meat and fish products have been preserved for centuries by salting them. More modern preservation methods are ultra-high temperature treatment and pasteurisation. All known preservation methods result in a change in the taste of the food. When adding salt or acids, this is sometimes desired. This effect is undesirable in foods that are generally considered to taste best when fresh, such as dairy products, soups and purées. Temperature-based preservation measures are usually used for these foods.

However, there are also foods that react extremely sensitively to heat and the taste of which should be influenced as little as possible by the preservation measure used, which is why salts and/or acids are not suitable for preservation. Examples of this are pasty foods made from starch-containing and protein-containing basic ingredients, in particular houmous.

Depending on the regional variant, houmous is made from chickpeas and/or beans as the basic ingredient. The basic ingredient is soaked, cooked and processed into the food base. The food base is then blended with the other ingredients to make houmous. Houmous tastes best when it is freshly made. When fresh houmous comes into contact with the ambient air or oxygen, it spoils very quickly. In order to be able to produce and sell houmous on an industrial scale, it is usually ultra-heat treated and packaged. This changes the taste of the houmous. With the currently known systems and methods, it is not possible to produce a pasty food, such as houmous, in a way that preserves it without having to heat the pasty food in a preservation step to kill the micro-organisms it contains.

Houmous, like all pasty foods with a high starch content and/or protein content, is a very delicate product and can spoil even through contact with the ambient air. Even production using systems known from prior art is challenging from a hygiene perspective and requires frequent cleaning of the system. In particular, pipelines can quickly become contaminated, thus forming an ideal breeding ground for micro-organisms.

### SUMMARY

The disclosure relates to a system for producing a pasty food from a starch-containing and/or protein-containing basic ingredient, at least a first supplementary ingredient and water, wherein the system has a vessel, a mixing device and a pipeline system, wherein the vessel has a vessel volume, a temperature control arrangement that is and/or can be brought into operative connection with the vessel volume, a vessel agitator arranged at least in sections within the vessel volume and a vessel inlet section, wherein a heat flow into and/or out of the vessel volume can be generated by the temperature control arrangement, wherein at least the basic ingredient and the water can be poured into the vessel volume through the vessel inlet section, and wherein mechanical work can be transferred to the ingredients arranged in the vessel volume by means of the vessel agitator, so that the basic ingredient can be processed into a pasty food base by means of the vessel, wherein the vessel has a vessel outlet section that is and/or can be connected to the vessel volume, wherein the vessel outlet section is and/or can be connected to a mixing inlet section of the mixing device by means of a first pipe section of the pipeline system, so that the food base can be transported from the vessel to the mixing device by means of the first pipe section, wherein the mixing device has a mixing volume and a mixing agitator arranged within the mixing volume, and wherein the mixing device has at least one ingredient inlet section through which at least the first supplementary ingredient can be introduced into the mixing volume, so that the pasty food can be produced by means of the mixing device.

The present disclosure provides a system, by means of which a long-life pasty food can be produced without the food being preserved in a separate preservation step.

This is achieved in that the system with an inert gas source is and/or can be brought into operative connection with an inert gas and/or has the inert gas source, wherein by means of the inert gas source an inert gas can be provided, wherein the vessel volume, the mixing volume and all pipe volumes of the pipeline system are and/or can be gas-conductingly connected to the inert gas source in such a way that the volumes can be filled and/or topped up with the inert gas, such that it is possible to prevent the food base and the food from coming into contact with oxygen and/or ambient air. Such a design of the system ensures that the multiplication of oxygen-breathing micro-organisms can be inhibited throughout the entire system.

It is thus advantageously provided that the pipeline system also has corresponding conveyor machines, for example conveyor pumps, screw conveyors, conveyor belts or similar, wherein the volumes surrounded by the conveyor machines can also be filled and/or topped up with the inert gas such that the food base and the food do not come into contact with the ambient air or oxygen even when passing through the conveyor machines.

The filling of all volumes relevant for the production of the pasty food with the inert gas has the result that, unlike in the case of the systems known from the prior art, even in those volumes in which the micro-organisms are not reduced by the processes, such as by boiling in the vessel, the reproduction of the micro-organisms is at least inhibited, such that the pasty food can be discharged from the system as a long-life product. In this context, “long-life” means that the pasty food has such a low population of micro-organisms after production that it can be stored for several weeks in a packaged state without the need for further preservation measures, such as ultra-high temperature processing or pasteurisation.

In order to distribute the inert gas as efficiently and effectively as possible throughout the system, in an advantageous implementation, it is provided that the system will have an inert gas distribution system with inert gas lines and inert gas flow control elements, wherein the inert gas can be introduced into the volumes of the system at least indirectly from the inert gas source by means of the inert gas distribution system. It is thus provided that the inert gas flow control elements can be used to control the flow of inert gas through the inert gas lines. Particularly preferably, the inert gas flow control elements are valves, in particular control and switching valves.

In a particularly cost-efficient embodiment of the system, it is advantageously provided that the system is designed such that nitrogen can be used as inert gas. Nitrogen is a cost-effective, readily available and easy-to-handle industrial gas. To adapt the system for the use of nitrogen, it is planned that the volumes will be sealed against the ambient air by means of suitable seals.

In a particularly preferred implementation, it is provided that the nitrogen inside the system is constantly maintained at overpressure, such that leaks can be easily detected by a pressure drop and the penetration of ambient air is prevented.

In an advantageous implementation, it is provided that the inert gas source has a gas generator, wherein the inert gas can be extracted from the ambient air by means of the gas generator. The design of the system makes it possible to operate the system without the need for inert gas to be supplied.

Since it is advantageously provided that the inert gas may be nitrogen in particular, a variety of methods are known by which nitrogen can be extracted from the ambient air. For example, nitrogen can be produced with a purity of up to 99.99999% by fractional distillation of liquefied air in air separation systems using the Linde process. To produce nitrogen with impurities of below 1 ppb (parts per billion), it is advantageous that the gas generator can have a gas purification device.

It is also possible and provided that the gas generator can work according to the membrane process. In this process, a gas stream with a pressure of 5 to 13 bar is pressed through a plastic membrane, wherein the diffusion rate of nitrogen and argon through the plastic membrane is significantly slower than that of oxygen, water and carbon dioxide, thus enabling the gas stream to be enriched with nitrogen on one pressure side of the plastic membrane.

In order to be able to produce the largest possible quantity of the pasty food using the system, in an advantageous implementation, it is provided that the system has at least two vessels and/or at least two mixing devices. It is provided that the pasty food can be produced in batches using the vessel of the system. “In batches” in the sense of the present disclosure means that a defined amount of the basic ingredient is filled into the vessel, soaked, cooked and processed with the supply of mechanical work to form the pasty food base, wherein this batch must first be removed from the vessel before the next batch of the pasty food can be produced. This production in batches means that downstream production systems with only one vessel cannot be utilized to full capacity on a permanent basis, which can lead to a loss of efficiency. Such efficiency losses can be reduced by using at least two vessels, in that the at least two vessels can be operated in such a way that the pasty food base is always available for feeding downstream production systems, in particular the mixing device(s).

It is also provided that the pasty food can be produced in batches in the mixing device from the pasty food base. For this purpose, the mixing volume can be filled with a defined quantity of the pasty food base. Even with the production of the pasty food in batches, downstream production systems cannot be utilized to full capacity in the long term by means of just one mixing device, which can also lead to efficiency losses here. Such efficiency losses can be reduced by using at least two mixing devices, in that the at least two mixing devices can be operated in such a way that the pasty food is always available for feeding downstream production systems, in particular a quality control and/or filling system.

It is advantageously provided that the system can be scaled in a simple manner by changing the number of vessels and/or mixing devices. The number of vessels and/or mixing devices can be increased if a larger quantity of the pasty food is to be produced and the number of vessels and/or mixing devices can be reduced if a smaller quantity of the pasty food is to be produced.

In order to be able to store finished batches of the pasty food, it is provided that the system has at least one storage container with a storage volume, a storage inlet section and a storage outlet section, wherein the storage inlet section is and/or can be connected to a mixing outlet section of the mixing device by means of a third pipe section of the pipeline system and wherein the storage volume is and/or can be brought into operative connection with the inert gas source in such a way that the storage volume can be filled and/or topped up with the inert gas, such that the food can be transported from the mixing device to the storage container by means of the third pipe section and stored in the storage volume without coming into contact with oxygen or ambient air. Such a design of the system ensures that the finished pasty food does not come into contact with oxygen and ambient air, even during process-related intermediate storage.

The storage containers make it possible for a stream of finished pasty food leaving the mixing device in batches to be smoothed and converted into a uniform stream of pasty food, so that the downstream production systems can be fed with the uniform stream of pasty food.

To package the finished food, in an advantageous implementation, it is provided that the system has at least one filling device with a filling inlet section, a filling arrangement and a sealing arrangement, wherein the filling inlet section is and/or can be connected to a storage outlet section of the storage container by means of a fourth pipe section of the pipeline system and/or to the mixing outlet section of the mixing device by means of a fifth pipeline section, such that the food can be transported from the storage container by means of the fourth pipe section and/or from the mixing device to the filling device by means of the fifth pipeline section, wherein the food can be filled in filling food container by means of the filling arrangement within a filling working volume, wherein the food containers can be closed and sealed within a sealing working volume by means of the sealing arrangement, and wherein the filling inlet section and all working volumes of the filling device are and/or can be brought at least indirectly into operative connection with the inert gas source in such a way that the food can be filled without coming into contact with ambient air or oxygen. The design of the system, with an integrated filling device, ensures that the pasty food can be processed in a timely manner, thus minimizing the risk of the food spoiling.

Alternatively, there is also the advantageous option of transporting the pasty food to an external filling device after its production. In this case, it is advantageously provided that the logistics containers used for transport can be filled and/or topped up with the inert gas, such that the pasty food can be transported to the external filling device without coming into contact with ambient air or oxygen.

In order to achieve the highest possible degree of automation in the production of the pasty food, in an advantageous implementation, it is provided that the system has at least one supplementary ingredient container, wherein the supplementary ingredient container has an ingredient volume and an ingredient outlet section, wherein the ingredient outlet section is connected to the ingredient inlet section of the mixing device by means of an ingredient pipe section of the pipeline arrangement, wherein the first supplementary ingredient and/or a further supplementary ingredient can be stored in the ingredient volume, wherein the ingredient volume is and/or can be brought into operative connection with the inert gas source in such a way that the ingredient volume can be filled and/or topped up with the inert gas, such that the first supplementary ingredient and/or the further supplementary ingredient can be transported from the supplementary ingredient container to the mixing device by means of the ingredient pipe section and can be stored in the ingredient volume without coming into contact with oxygen or ambient air. With such a design of the system, the supplementary ingredients can be automatically introduced into the mixing volume.

The use of supplementary ingredient containers that can be filled and/or topped up with inert gas is particularly advantageous because it prevents germs from the ambient air from entering the pasty food via the supplementary ingredients. Furthermore, the amount of oxygen introduced into the pasty food by the supplementary ingredients can be minimized by using inert gas in the supplementary ingredient containers as well. This design of the system is a simple way of increasing the shelf life of the pasty food.

In order to further reduce the risk of contamination of the pasty food, in an advantageous embodiment of the system, it is provided that the system has at least one water reservoir, wherein the water reservoir has a water volume and a water outlet section, wherein the water outlet section is connected to the ingredient inlet section of the mixing device by means of a sixth pipe section of the pipeline system and/or to the vessel inlet section of the vessel by means of a seventh pipe section, wherein the water can be stored in the water volume, wherein the water volume is and/or can be brought into operative connection with the inert gas source in such a way that the water volume can be filled and/or topped up with the inert gas, such that the water can be transported from the water reservoir to the mixing device by means of the sixth pipe section and/or to the vessel by means of the seventh pipe section and can be stored in the water volume without coming into contact with oxygen or ambient air. Such a design of the system achieves that the amount of oxygen dissolved in the water and a germ load of the water due to the absorption of germs from the ambient air can be reduced.

Gases from the ambient air dissolve in water. Whether a gas dissolves in water or escapes from the water into the ambient air depends on which of the two media, water or ambient air, has the greater partial pressure of the respective gas, wherein the transition always occurs from high partial pressure to low partial pressure. The storage of the water in the water reservoir filled with the inert gas ensures that the oxygen dissolved in the water outgasses and that nitrogen is dissolved in the water instead. The outgassed oxygen is no longer available to any micro-organisms present in the further processing and the risk of the pasty food base and/or the pasty food being contaminated can thus be reduced.

In a particularly advantageous implementation, it is provided that the inert gas in the water reservoir can be exchanged cyclically and/or continuously, in order to be able to reduce the oxygen content of the water as much as possible.

In order to be able to also produce houmous using the system, it is advantageously provided that the system is configured for the production of houmous, wherein the basic ingredient is chickpeas and/or beans, wherein the chickpeas and/or beans can be processed into the basic ingredient by means of the vessel, wherein the first supplementary ingredient is tahini and/or a similar sesame paste, wherein the system has a first supplementary ingredient container in which the first supplementary ingredient can be stored, wherein the system has a second supplementary ingredient container in which a second supplementary ingredient can be stored, wherein the second supplementary ingredient is a cooking oil, wherein the system has a third supplementary ingredient container, wherein the third supplementary ingredient is an acidifier, wherein the first supplementary ingredient container with a first ingredient pipe section, the second supplementary ingredient container with a second ingredient pipe section and the third supplementary ingredient container with a third ingredient pipe section are connected to the ingredient inlet section of the mixing device, such that the first, second and third supplementary ingredients can be introduced into the mixing volume by means of the ingredient pipe sections. Houmous can be produced using the system.

Adaptation in the sense of the present disclosure means, in particular, that the containers have suitable auxiliary elements, for example stirrers, filters or the like, in order to enable further processing of the ingredient stored in each container. Furthermore, it is provided that the conveyor machines of the pipeline system are adapted to a consistency of ingredients for the houmous, for example by having a rotary lobe pump in the piping system operatively associated with the first supplementary ingredient container.

In order to enable easy cleaning of the system and thus to be able to easily maintain the required level of hygiene, in an advantageous implementation, it is provided that the system will have a rinsing cleaning device by means of which at least the vessel and the mixing device can be cleaned. By means of the rinsing cleaning device, the CIP process (cleaning in place) can advantageously be carried out. In this process, the system can be cleaned without significant disassembly by precisely defining cleaning agents, pressures, temperatures and times, thus enabling a reproducible cleaning process.

It is advantageously provided that the rinsing cleaning device has a central unit and a rinsing line arrangement, wherein the rinsing line arrangement has cleaning supply lines and return lines, wherein a cleaning agent can be supplied at least from the central unit to the vessel and from the central unit to the mixing device by means of the cleaning supply lines, such that the volumes of the vessel and the mixing device can be rinsed with the cleaning agent. Thus, it is provided that the return lines are and/or can be brought into operative contact with the volumes of the vessel and the mixing device in such a way that the contaminated rinsing agent can be directed from the volumes to the central unit.

Particularly preferably, it is provided that all volumes of the system are and/or can be brought into operative contact with the rinsing cleaning device, such that the entire system can be cleaned by means of the rinsing cleaning device. It is also advantageously provided that the pipeline arrangement has cleaning access sections, wherein the cleaning access sections are and/or can be connected by means of the cleaning supply lines and the return lines, such that individual pipe sections of the pipeline arrangement can be cleaned separately.

In a particularly advantageous implementation, it is provided that the system can be cleaned during operation without having to interrupt the production of the pasty food. To achieve this, it is provided that the system has at least two vessels and two mixing devices, which are operated alternately to produce the pasty food or pasty food base and are then cleaned.

It is envisaged that the rinsing cleaning device advantageously also has a dosing device by means of which a composition of the cleaning agent can be changed. For example, it is possible and provided for that the cleaning agent can have different compositions for different rinsing cleaning processes. In addition, it is also provided that the rinsing cleaning device can have a heating arrangement by means of which the rinsing agent can be heated to a defined temperature so that the volumes to be cleaned can also be boiled out.

In order to prevent contamination of cleaned volumes, it is advantageously provided that the rinsing cleaning device and the inert gas distribution system are adapted to each other in such a way that the volumes can be filled and/or refilled with the inert gas even if they are being cleaned and/or have been cleaned by means of the rinsing cleaning device.

In order to monitor sufficient filling of the system with the inert gas, in an advantageous implementation, it is provided that the system has a monitoring device, wherein the monitoring device has at least one sensor element and at least one evaluation arrangement, wherein the sensor element and the evaluation arrangement are adapted to one another and are brought into operative connection with at least one volume of the system in such a way that it is possible to determine by means of the monitoring device whether a proportion of inert gas within the at least one volume of the system is sufficient to counteract spoilage of the food. It is advantageously provided that the inert gas content is adjustable so that the oxygen content in the volumes is below 1% by volume, preferably below 0.5% by volume, and particularly preferably below 0.2% by volume. The low oxygen content ensures that the putrefaction processes in the pasty food base and in the pasty food itself are almost completely stopped, thus increasing the shelf life of the pasty food.

For this purpose, it is advantageously provided that the monitoring device can act on the inert gas distribution system to adjust the inert gas proportion in the system, for example by means of suitable valves and actuators.

Particularly preferably, the system has a multiplicity of sensor elements, which are operatively connected to the evaluation arrangement, wherein the sensor elements are distributed within the system such that as many different sections of the system as possible can be monitored.

The disclosure also relates to a method for producing a pasty food using one of the previously described systems, wherein the pasty food base is first produced from the basic ingredient in a reduction cooking process, wherein the reduction cooking process has a soaking step and a cooking step following the soaking step, wherein the basic ingredient is soaked in the soaking step together with the water while heat is applied by means of the temperature control arrangement, wherein the basic ingredient soaked in the soaking step is processed into the pasty food base in the cooking step with the supply of heat by means of the temperature control arrangement and with the supply of mechanical work by means of the vessel agitator, wherein in a mixing process following the reduction cooking process, the pasty food is produced from the pasty food base and the at least one supplementary ingredient by means of the mixing device, wherein the mixing process has a pouring step and a blending step following the pouring step, wherein in the pouring step the pasty food base and the at least one supplementary ingredient are poured into the mixing volume, wherein in the blending step the pasty food base and the at least one supplementary ingredient are blended together by means of the mixing agitator such that the pasty food is formed, wherein the vessel volume and the mixing volume are filled or topped up with the inert gas in an inert gas introduction step prior to the reduction cooking process and are brought into operative connection with the inert gas source during the reduction cooking process and during the mixing process in such a way that the food base and the food are prevented from coming into contact with oxygen and/or ambient air. The shelf life of the pasty food can be increased by producing the pasty food using the method, in particular by using inert gas.

The reduction cooking process breaks down the basic ingredient so that the nutrients can be more easily utilized. In addition, any remaining germs and pathogens are killed. The filling of the vessel volume with the inert gas prevents any residual germs and/or pathogens that may be present from multiplying again after the reduction cooking process.

It is advantageously provided that an overpressure can be set in the cooking step of the reduction cooking process in the vessel volume, such that a cooking temperature can be raised above 100° C.. The cooking temperature is particularly preferably more than 120° C., wherein the vessel pressure in the vessel volume is approx. 2 bar.

In an advantageous implementation of the method, it is provided that the method is performed by means of a system with a storage container, wherein the mixing process is followed by an intermediate storage step in which the pasty food is fed from the mixing device into the storage container, wherein the storage volume is filled or topped up with the inert gas in the inert gas introduction step and wherein the storage container is brought into operative connection with the inert gas source during the intermediate storage step in such a way that the food is prevented from coming into contact with oxygen and/or the ambient air. By means of the intermediate storage step, fluctuations in the production of the pasty food, which can have an impact on downstream production systems, for example on filling systems, are minimized.

The use of the inert gas in the intermediate storage step also improves the shelf life of the pasty food.

In an advantageous embodiment, it is provided that the method is performed using a system, which has a filling device, wherein the mixing process or the intermediate storage step is followed by a packaging process, in which the food is packaged in the food container by means of the filling device, wherein the packaging process has a filling step and a sealing step following after the filling step, wherein in the filling step the food is first fed from the mixing device and/or the storage container to the filling device, wherein the food is subsequently filled into the food container by means of the filling arrangement of the filling device within the filling working volume, wherein the filled food containers are closed and sealed by means of the sealing arrangement in the sealing step, which follows the filling process, wherein all working volumes of the filling device are filled or topped up with the inert gas in the inert gas introduction step and are brought at least indirectly into operative connection with the inert gas source in such a way that the food is filled without coming into contact with ambient air or oxygen.

In an advantageous implementation, it is provided that the pasty food base and/or the pasty food is cooled after and/or during the individual method steps. Cooling to temperatures below 10° C. is particularly preferable.

It is advantageously provided that in the inert gas introduction step at least the vessel volume and the mixing volume are topped up with the inert gas. Particularly preferably, all volumes of the system are topped up with the inert gas.

Further advantageous implementations are explained with reference to exemplary embodiments shown in the drawings. In the drawings:

### BRIEF DESCRIPTION OF THE DRAWINGS

FIGS. 1A to 5 show schematically illustrated views of embodiments of the system for producing a pasty food.

FIG. 6 shows a schematic illustration of an embodiment of the method for producing a pasty food.

### DETAILED DESCRIPTION

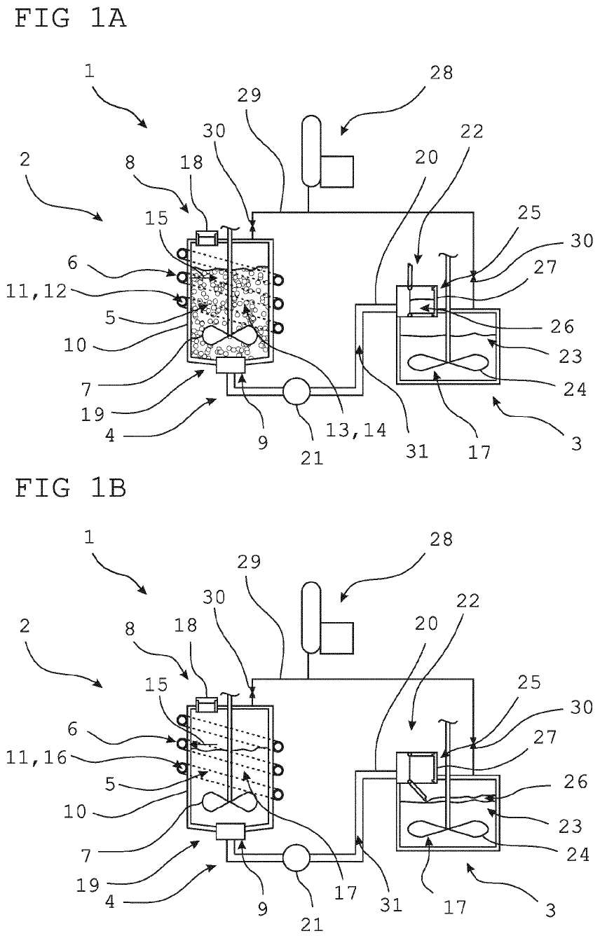

FIGS. 1A and 1B show a schematically illustrated view of an embodiment of the system 1 for producing a pasty food. The system 1 has a vessel 2, a mixing device 3 and a pipeline system 4. The vessel 2 has a vessel volume 5, a temperature control arrangement 6, a vessel agitator 7, a vessel inlet section 8 and a vessel outlet section 9. The vessel agitator 7 is operatively connected to a drive unit (not shown or labelled) and extends into the vessel volume 5. The vessel agitator 7 shown is only illustrated schematically.

The schematically illustrated temperature control device 6 of the vessel 2 surrounds the vessel 2 in sections and is thermodynamically operatively connected to the vessel volume 5 via a vessel wall 10 surrounding the vessel volume 5. The illustrated temperature control arrangement 6 surrounds the temperature control volume 11 and is designed as a pipe spiraling around the vessel wall 10. FIG. 1B shows the vessel 2 of the system 1 in a cooking mode, in which the temperature control volume 11 is flowed through by saturated steam 12 at a pressure of 3 bar and at a temperature of approximately 134° C. The steam 12 transfers thermal energy to a starch-containing and protein-containing basic ingredient 13 arranged within the vessel volume 5 and water 14 arranged in the vessel volume 5, such that a heat flow 15 is generated into the vessel. As a result, the water 14 is brought to the boil and the basic ingredient 13 is cooked in the vessel 2. At the same time, the vessel agitator 7 introduces mechanical work into the vessel volume 5, such that the basic ingredient 13 is broken down and mixed with the water 14.

In contrast, FIG. 1B shows the vessel 2 of the system 1 in a cooling mode, in which the temperature control volume 11 is flowed through by cooling water 16 at normal pressure and at a temperature of approximately 15° C. The cooling water 16 absorbs thermal energy from a pasty food base 17 that has previously been produced in the vessel 2 from the basic ingredient 13 and the water 14. When the vessel 2 is switched to cooling mode, the heat flow 15 is directed out of the vessel 2, such that the pasty food base 17 can be cooled.

The vessel inlet section 8 of the vessel 2 shown in FIGS. 1A and 1B is only shown schematically. The vessel inlet section 8 shown makes it possible to fill the vessel 2 with the basic ingredient 13 and the water 14 in batches. A closure element 18 is arranged in the vessel inlet section 8, by means of which the vessel volume 5 is sealed in a gas-tight manner. The closure element 18 is designed and adapted to the vessel inlet section 8 in such a way that an overpressure can be set in the vessel volume 5 without the closure element 8 losing its sealing effect.

The vessel outlet section 9 of the vessel 2 is located in an area of the vessel 2 opposite the vessel inlet section 8 and opens into a vessel sump 19 on the vessel side. The vessel sump 19 is the deepest section of the vessel volume 5, in which the basic ingredient 13, the water 14 and the pasty food base 17 collect under the influence of gravity at the vessel 2 installation site.

The vessel outlet section 8 is followed by a first pipe section 20 of the pipeline system 4. A pump 21 is arranged in the first pipe section 20, which is suitable for pumping the pasty food base 17. The first pipe section 20 is connected to a mixing inlet section 22 of the mixing device 3, such that the food base 17 can be transported from the vessel 2 to the mixing device 3 by means of the first pipe section 20 and the pump 21.

The mixing device 3 has a mixing volume 23 and a mixing agitator 24 arranged within the mixing volume 23. The mixing agitator 24 can be used to introduce mechanical work into the mixing volume 23. In the embodiment of the system 1 shown in FIGS. 1A and 1B, the mixing volume 23 is filled with the pasty food base 17.

The mixing device 3 has an ingredient inlet section 25, in which the first supplementary ingredient 26 can be poured into the mixing volume 23 by means of sluice arrangement 27, which is shown schematically. In FIG. 1A, the supplementary ingredient 26 is filled in a sluice chamber (not labelled) of the sluice arrangement 27, wherein the sluice chamber is open to the outside. In FIG. 1B, the sluice chamber of the sluice arrangement 27 is open towards the mixing volume 23 and the first supplementary ingredient is filled into the mixing volume 23. The pasty food base 17 and the first supplementary ingredient 26 are shown in FIG. 1B in an unmixed state. By switching on the mixing agitator 24, the pasty food base 17 and the first supplementary ingredient 26 can be mixed to form the pasty food.

The system 1 shown in FIGS. 1A and 1B has an inert gas source 28. The inert gas source 28 is designed as a gas generator that extracts nitrogen from the ambient air and provides the nitrogen as an inert gas for the system 1. The system 1 also has inert gas lines 29 and inert gas flow control elements 30, which form an inert gas distribution system (not labelled). The inert gas flow control elements 30 are designed as two-way valves, by means of which the inert gas lines 29 can be closed in sections. In the system shown, the inert gas lines 29 lead into the vessel volume 5 and the mixing volume 23, such that the inert gas can be fed directly into these volumes 5, 23. A first pipe volume 31 of the first pipe section 20 can be filled indirectly with the inert gas through the vessel volume 5 and the mixing volume 23.

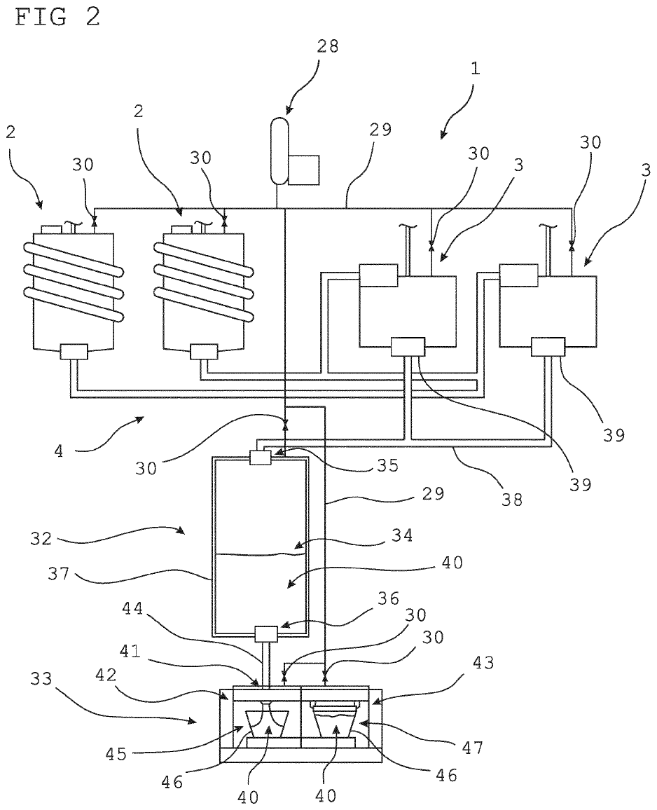

FIG. 2 shows a schematically illustrated view of a further embodiment of the system 1, which system, in addition to two vessels 2, two mixing devices 3, the pipeline system 4, the inert gas source 28, the inert gas lines 29 and the inert gas flow control elements 30, also has a storage container 32 and a filling device 33.

Each of the storage containers 32 has a storage volume 34, a storage inlet section 35 and a storage outlet section 36. The storage volume 34 is surrounded by a storage wall 37. The storage inlet section 35 is connected to a mixing outlet section 39 of the mixing device 3 by means of a third pipe section 38 of the pipeline system 4. The pasty food 40 can be pumped through the third pipe section 38 into the storage volume 34 of the respective storage container 32. The storage volumes 34 of the storage container 32 shown in FIG. 2 are each half-filled with the pasty food 40.

In the area of the storage inlet section 35, an inert gas line 29 is connected to the storage tank 32, which opens into the storage volume 34. The storage volume 34 is operatively connected to the inert gas source 28 by means of the inert gas line 29, such that the storage volume 34 can be filled with the inert gas.

The filling device 33 of the system 1 shown in FIG. 2 has a filling inlet section 41, a filling arrangement 42 and a sealing arrangement 43. The filling inlet section 41 of the filling device 33 is connected to the storage outlet sections 36 of the storage container 32 by means of two fourth pipe sections 44 of the pipeline system 4, such that the pasty food 40 can be transported from the storage containers 32 to the filling device 33.

The filling device 33 has a filling working volume 45, which surrounds the filling arrangement 42 in sections. A food container 46, which is filled with the pasty food 40, is arranged within the filling working volume 45 in a schematically represented manner. The filling volume 45 is connected to the inert gas source 28 by means of an inert gas line 29 and filled with the inert gas.

The filling device 33 of the system 1 shown in FIG. 2 also has a sealing working volume 47, which surrounds the sealing arrangement 43 in sections. A food container 46 filled with the pasty food 40 is arranged within the sealing working volume 47. The food container 46 shown has already been closed by means of the sealing arrangement 43. The sealing working volume 47 is connected to the inert gas source 28 by means of an inert gas line 29 and filled with the inert gas.

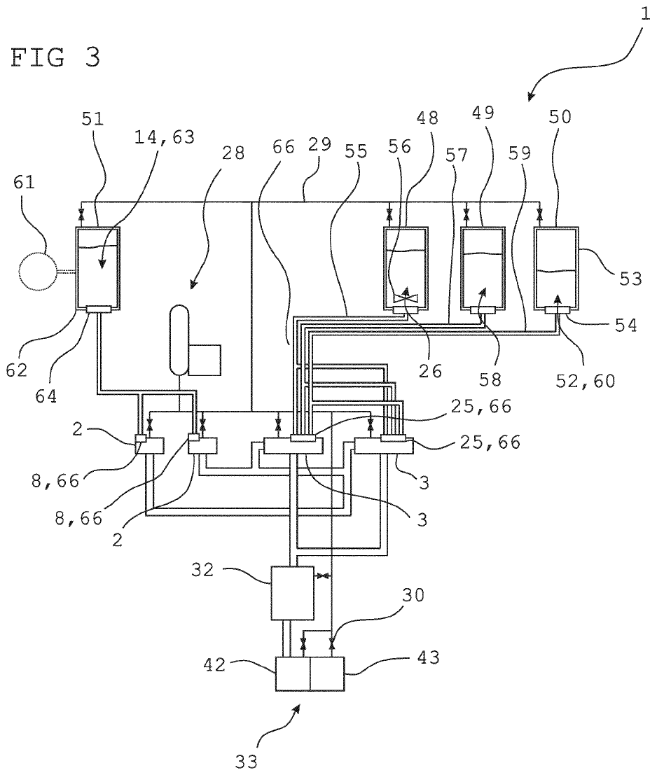

Unlike the embodiments shown in FIGS. 1A to 2, the embodiment of the system 1 for producing a pasty food shown in FIG. 3 has a first supplementary ingredient container 48, a second supplementary ingredient container 49, a third supplementary ingredient container 50 and a water reservoir 51. The vessel 2, the mixing device 3, the storage container 32 and the filling device 33 are only illustrated schematically in FIG. 3.

The supplementary ingredient containers 48, 49, 50 each have an ingredient volume 52, which is surrounded by an ingredient container wall 53, and a supplementary ingredient section 54. The ingredient outlet section 54 of the first supplementary ingredient container 48 is connected to the ingredient inlet section 25 of the mixing device 3 by means of a first ingredient pipe section 55, wherein the first supplementary ingredient 26 is stored in the first supplementary ingredient container. The ingredient outlet section 54 of the second supplementary ingredient container 49 is connected to the ingredient inlet section 25 of the mixing device 3 by means of a second ingredient pipe section 57, wherein the second supplementary ingredient 58 is stored in the second supplementary ingredient container 49. The third supplementary ingredient container 50 is connected to the ingredient inlet section 25 by means of a third ingredient pipe section 59, wherein a third supplementary ingredient 60 is stored in the third supplementary ingredient container 50.

The ingredient volumes 52 of the supplementary ingredient containers 48, 49, 50 are each operatively connected to the inert gas source 28 by means of an inert gas line 29 and topped up with the inert gas.

The first supplementary ingredients 26, 58, 60 can be transported from the supplementary ingredient containers 48, 49, 50 to the mixing device 3 by means of the ingredient pipe sections 55, 57, 59. The fact that the ingredient volumes 52 are filled with inert gas means that the supplementary ingredients 26, 58, 60 can be stored without coming into contact with oxygen or ambient air.

The water reservoir 51 in the system 1 shown in FIG. 3 is connected to a fresh water source 61. As a result of the water 14 being stored in the water volume 63 of the water reservoir 51 that has been topped up with the inert gas, the gases dissolved in the water 14 are exchanged with the inert gas. The water reservoir 51 has a water volume 63 surrounded by a water container wall 62 and a water outlet section 64. The water outlet section 64 is connected to the ingredient inlet section 25 of the mixing device 3 by means of a sixth pipe section 65 of the pipeline arrangement 4. Water 14 is stored inside the water volume 63. The water volume 63 is connected to the inert gas source 28 by means of one of the inert gas lines 29 and topped up with the inert gas.

The water 14 can be transported from the water reservoirs 51 to the vessels 2 by means of the sixth pipe section 65. Because the water volume 63 is filled with inert gas, the water 14 inside the water volume is stored without coming into contact with oxygen or ambient air.

The system 1 shown in FIG. 3 is configured to produce houmous. The basic ingredient 13 for producing the pasty food base 17 is chickpeas. The first supplementary ingredient 26 is tahini. Due to the high viscosity of tahini, the first supplementary ingredient container 48 has a supplementary ingredient agitator 56 (only illustrated schematically), by means of which the first supplementary ingredient 26 in the form of tahini can be conveyed to the ingredient outlet section 54 of the first supplementary ingredient container 48. The second supplementary ingredient 58 is a cooking oil. The third supplementary ingredient 60 is an acidifier.

The system 1 also has measuring arrangements 66, which are arranged in the vessel inlet sections 8 and in the ingredient inlet sections 25, in order to be able to determine the amount of water 14 and supplementary ingredients 26, 58, 60 fed into the vessel 2 and the mixing devices 3.

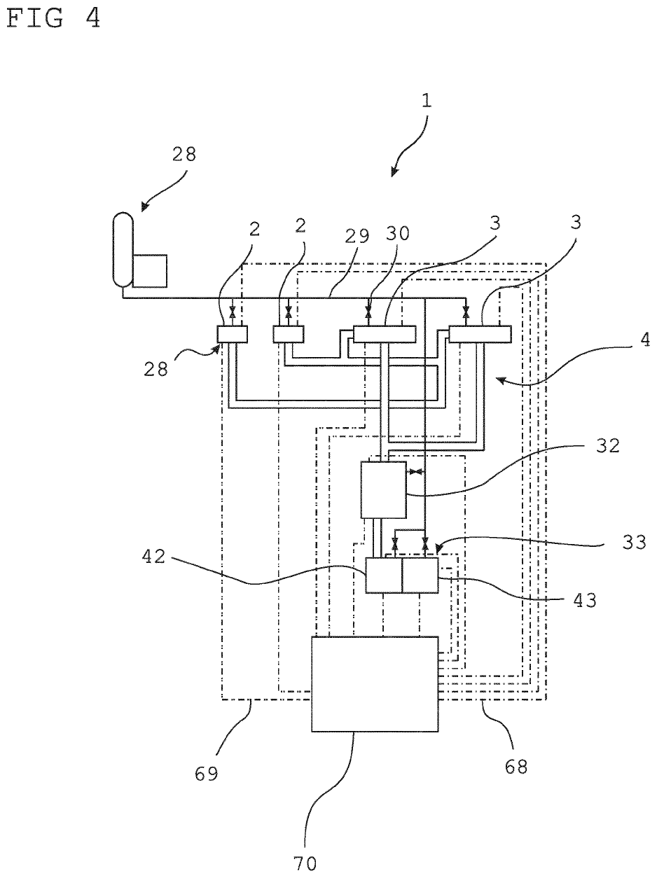

FIG. 4 shows a system 1 for producing a pasty food, which has a rinsing cleaning device 67. The rinsing cleaning device 67 has rinsing lines 68 (shown by dash-dot lines), return lines 69 (shown by dash-two-dot lines) and a cleaning unit 70. Only one of the rinsing lines 68 and one of the return lines is labelled. The rinsing cleaning device 67 is only represented schematically and only the rinsing lines 68 and return lines 69 are shown, by means of which a cleaning liquid can be introduced into and discharged from the vessels 2, the mixing devices 3, the storage container 32 and the filling device 33. The supplementary ingredient containers of the water reservoirs as well as the associated pipe sections and ingredient pipe sections are not shown.

The functioning of the rinsing cleaning device 67 is explained below using the example of one of the vessels 2 as an example. The other devices are cleaned in a similar way. The cleaning liquid is pumped from the cleaning unit 70 into the vessel 2 via the rinsing line 68 leading to the vessel 2. Contaminants inside the vessel 2 are dissolved by the cleaning liquid and/or washed away with the cleaning liquid. The return line 69 is connected to the vessel sump 19 of the vessel 2 and the contaminated cleaning liquid is transported back to the cleaning unit 70 through the return line 69.

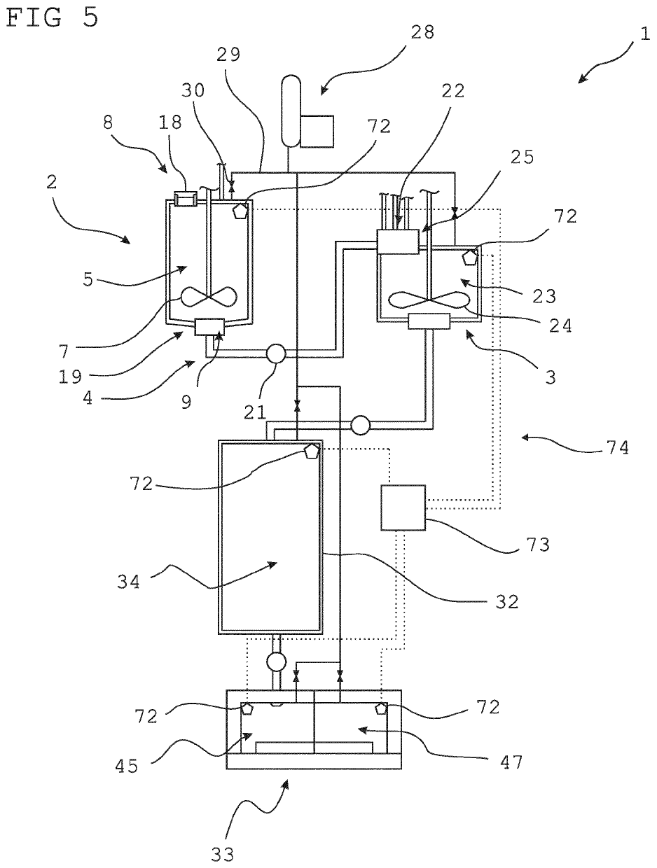

FIG. 5 shows a schematic representation of an embodiment of the system 1 for producing a pasty food, which has a vessel 2, a mixing device 3, a storage container 32, a filling device 33 and a monitoring device 71. The supplementary ingredient container and the water container are not shown in FIG. 5. The monitoring device 71 has five sensor elements 72 and an evaluation arrangement 73. Each of the sensor elements 72 is operatively connected to the vessel volume 5, the mixing volume 23, the storage volume 34, the filling working volume 45 and the sealing working volume 47. The sensor elements 72 are operatively connected in a signal-conducting manner (shown by dotted lines) to the evaluation arrangement 73 and are designed as gas sensors, by means of which the concentration of oxygen within the volumes 5, 23, 34, 45 can be determined. A rule (not shown or labelled) is stored on the evaluation arrangement 73, by means of which it is possible to determine, on the basis of sensor signals generated by the sensor elements 72, whether a sufficient proportion of inert gas has been introduced into the volumes 5, 23, 34, 45 to counteract spoilage of the food.

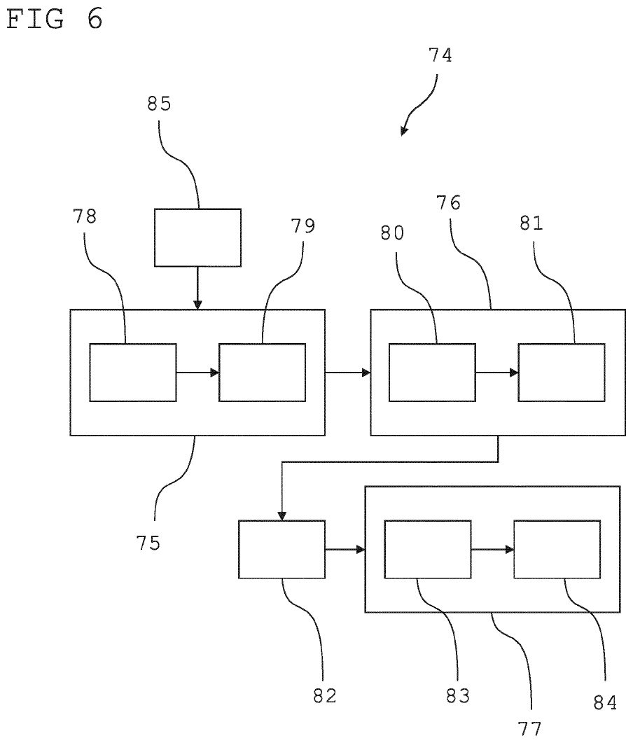

FIG. 6 shows a schematic representation of a method 74 for producing the pasty food using one of one of the previously described systems. The method 74 has a reduction cooking process 75, a mixing process 76 and a packaging process 77.

In the reduction cooking process 75, the basic ingredient is first soaked in a soaking step 78 together with the water while heat is applied. In a cooking step 79 of the reduction cooking process 75, which follows the soaking step 78, the basic ingredient soaked in the soaking step 78 is processed into the pasty food base with the supply of heat and mechanical work.

The reduction cooking process 75 is followed by the mixing process 76. In the mixing process 76, the pasty food is produced from the pasty food base and the supplementary ingredients by means of the mixing device. The mixing process 76 has a pouring step 80 and a blending step 81 following the pouring step 80. In the pouring step 80, the pasty food base and the supplementary ingredients are poured into the mixing volume. In the subsequent blending step 81, the pasty food base and the supplementary ingredients are blended together by means of the mixing agitator, thus producing the pasty food.

The method 1 shown also has an intermediate storage step 82 following the mixing process 76, in which the pasty food is transported from the mixing device into the storage volume of the storage container. In particular, the intermediate storage step 82 is used to smooth the provision of pasty food in batches by the mixing device and to provide a constant mass flow of pasty food for the packaging process 77 that follows the intermediate storage step 82.

The packaging process 77 following the intermediate storage step 82 has a filling step 83 and a sealing step 84. In the filling step 83, the pasty food is first conveyed from the storage container to the filling device and then filled into the food containers within the filling working volume by means of the filling arrangement of the filling device.

In the sealing step 84, which follows the filling step 83, the filled food container is closed and sealed by means of the sealing arrangement of the filling device.

The method shown in FIG. 6 also has an inert gas introduction step 85. In the embodiment of the method 74 for producing a pasty food shown, the inert gas introduction step 85 takes place once before the reduction cooking process 75. In the inert gas introduction step 85, the vessel volume, the mixing volume, the storage volume, the filling working volume and the sealing working volume are filled with the inert gas so that oxygen and ambient air are displaced from the volumes.

In the illustrations of FIGS. 1A to 5, in some cases individual elements of several elements of the same type are labelled with one reference numeral by way of example.

### LIST OF REFERENCE CHARACTERS

1. System
2. Vessel
3. Mixing device
4. Pipeline system
5. Vessel volume
6. Temperature control arrangement
7. Vessel agitator
8. Vessel inlet section
9. Vessel outlet section
10. Vessel wall
11. Temperature control volume
12. Steam
13. Basic ingredient
14. Water
15. Heat flow
16. Cooling water
17. Pasty food base
18. Closure element
19. Vessel sump
20. First pipe section
21. Pump
22. Mixing inlet section
23. Mixing volume
24. Mixing agitator
25. Ingredient inlet section
26 First supplementary ingredient
27. Sluice arrangement
28. Inert gas source
29. Inert gas line
30. Inert gas flow control element
31. First pipe volume
32. Storage container
33. Filling device
34. Storage volume
35. Storage inlet section
36. Storage outlet section
37. Storage wall
38. Third pipe section
39. Mixing outlet section
40. Pasty food
41 Filling inlet section
42. Filling arrangement
43. Sealing arrangement
44. Fourth pipe section
45. Filling working volume
46. Food container
47. Sealing working volume
48. First supplementary ingredient container
49. Second supplementary ingredient container
50. Third supplementary ingredient container
51. Water reservoir
52. Ingredient volume
53. Ingredient container wall
54. Ingredient outlet section
55. First ingredient pipe section
56. Supplementary ingredient agitator
57. Second ingredient pipe section
58. Second supplementary ingredient
59. Third ingredient pipe section
60. Third supplementary ingredient
61. Fresh water source
62. Water container wall
63. Water volume
64. Water outlet section
65. Sixth pipe section
66. Measuring arrangement
67. Rinsing cleaning device
68. Rinsing lines
69. Return lines
70. Cleaning unit
71. Monitoring device
72. Sensor element
73. Evaluation arrangement
74. Method
75. Reduction cooking process
76. Mixing process
77. Packaging process
78. Soaking step
79. Cooking step
80. Pouring step
81. Blending step
82. Intermediate storage step
83. Filling step
84. Sealing step
85. Inert gas introduction step

1.-15. (Canceled)

16. A system (1) for producing a pasty food (40) from a starch-containing and/or protein-containing basic ingredient (13), at least a first supplementary ingredient (26), and water (14), the system (1) comprising:
a vessel (2) having a vessel volume (5);
a mixing device (3);
a pipeline system (4);
a temperature control arrangement (6) that is and/or can be brought into operative connection with the vessel volume (5);
a vessel agitator (7) arranged at least in sections within the vessel volume (5); and
a vessel inlet section (8),
wherein a heat flow (15) into the vessel volume (5) and/or out of the vessel volume (5) can be generated by the temperature control arrangement (6),
wherein at least the basic ingredient (13) and the water (14) can be poured into the vessel volume (5) through the vessel inlet section (8), and
wherein mechanical work can be transferred to the ingredients (13, 14) arranged in the vessel volume (5) by the vessel agitator (7), whereby the basic ingredient (13) can be processed into a pasty food base (17) by the vessel (2),
wherein the vessel (2) has a vessel outlet section (9) that is and/or can be connected to the vessel volume (5),
wherein the vessel outlet section (9) is and/or can be connected to a mixing inlet section (22) of the mixing device (3) by a first pipe section (20) of the pipeline system (4), so that the food base (17) can be transported from the vessel (2) to the mixing device (3) by the first pipe section (20),
wherein the mixing device (3) has a mixing volume (23) and a mixing agitator (24) arranged within the mixing volume (23), and
wherein the mixing device (3) has at least one ingredient inlet section (25) through which at least the first supplementary ingredient (26) can be introduced into the mixing volume (23), so that the pasty food (40) can be produced by means of the mixing device (3),
wherein the system (1) is and/or can be brought into operative connection with an inert gas source (28) and/or has the inert gas source (28),
wherein by the inert gas source (28) an inert gas can be provided,
wherein the vessel volume (5), the mixing volume (23) and all pipe volumes (31) of the pipeline system (4) are and/or can be gas-conductingly connected to the inert gas source (28) in such a way that the vessel volume (5), the mixing volume (23), and the pipe volumes (31) can be filled and/or topped up with the inert gas, whereby it is possible to prevent the food base (17) and the food (40) from coming into contact with oxygen and/or ambient air.

17. The system (1) according to claim 16,
further comprising an inert gas distribution system with inert gas lines (29) and inert gas flow control elements (30),
wherein the inert gas can be introduced at least indirectly from the inert gas source (28) into the volumes (5, 23, 31) of the system (1) by means of the inert gas distribution system.

18. The system (1) according to claim 16,
wherein the system (1) is designed such that nitrogen can be used as inert gas.

19. The system (1) according to claim 18,
wherein the inert gas source (28) has a gas generator, wherein the inert gas can be extracted from the ambient air by means of the gas generator.

20. The system (1) according to claim 16,
wherein the system (1) has at least two vessels (2) and/or at least to mixing devices (3).

21. The system (1) according to claim 16, further comprising
at least one storage container (32) with
a storage volume (34),
a storage inlet section (35), and
a storage outlet section (36),
wherein the storage inlet section (35) is and/or can be connected to a mixing outlet section (39) of the mixing device (3) by a third pipe section (38) of the pipeline system (4) and
wherein the storage volume (34) is and/or can be brought into operative connection with the inert gas source (28) in such a way that the storage volume (34) can be filled and/or topped up with the inert gas, such that the food (40) can be transported from the mixing device (3) to the storage container (32) by the third pipe section (38) and stored in the storage volume (34) without coming into contact with oxygen or ambient air.

22. The system (1) according to claim 21, further comprising
at least one filling device (33) with
a filling inlet section (41),
a filling arrangement (42), and
a sealing arrangement (43),
wherein the filling inlet section (41) is and/or can be connected
to a storage outlet section (36) of the storage container (32) by a fourth pipe section (44) of the pipeline system (4) and/or
to the mixing outlet section (39) of the mixing device (3) by a fifth pipe section,
such that the food (40) can be transported from the storage container (32) by the fourth pipe section (44) and/or from the mixing device (3) to the filling device (33) by the fifth pipe section,
wherein the food (40) can be filled in filling working volumes (46) by the filling arrangement (42) within a filling working volume (45),
wherein the filling working volumes (46) can be closed and sealed within a sealing working volume (47) by the sealing arrangement (43), and
wherein the filling inlet section (41) and all working volumes (46, 47) of the filling device (33) are and/or can be brought at least indirectly into operative connection with the inert gas source (28) in such a way that the food (40) can be filled without coming into contact with ambient air or oxygen.

23. The system (1) according to claim 16, further comprising
at least one supplementary ingredient container (48, 49, 50),
wherein the supplementary ingredient container (48, 49, 50) has an ingredient volume (52) and an ingredient outlet section (54),
wherein the ingredient outlet section (54) is connected to the ingredient inlet section (25) of the mixing device (3) by an ingredient pipe section (55, 57, 59) of the pipeline system (4),
wherein the first supplementary ingredient (26) and/or a further supplementary ingredient (58, 60) can be stored in the ingredient volume (52),
wherein the ingredient volume (52) is and/or can be brought into operative connection with the inert gas source (28) in such a way that the ingredient volume (52) can be filled and/or topped up with the inert gas, such that the first supplementary ingredient (26) and/or the further supplementary ingredient (58, 60) can be transported from the supplementary ingredient container (48, 49, 50) to the mixing device (3) by the ingredient pipe section (55, 57, 59) and can be stored in the ingredient volume (52) without coming into contact with oxygen or ambient air.

24. The system (1) according to claim 23, further comprising
at least one water reservoir (51),
wherein the water reservoir (51) has a water volume (63) and a water outlet section (64),
wherein the water outlet section (64) is connected to the ingredient inlet section (25) of the mixing device (3) by a sixth pipe section (65) of the pipeline system (4) and/or to the vessel inlet section (8) of the vessel (2) by a seventh pipe section,
wherein the water (14) can be stored in the water volume (63),
wherein the water volume (63) is and/or can be brought into operative connection with the inert gas source (28) in such a way that the ingredient volume (52) can be filled and/or topped up with the inert gas, such that the water (14) can be transported from the water reservoir (51) to the mixing device (3) by means of the sixth pipe section (65) and/or to the vessel (2) by means of the seventh pipe section and can be stored in the water volume (63) without coming into contact with oxygen or ambient air.

25. The system (1) according to claim 23,
wherein the system (1) is configured for producing houmous,
wherein the basic ingredient (13) is chickpeas and/or beans,
wherein the chickpeas and/or beans can be processed into the basic ingredient (13) by means of the vessel (2),
wherein the first supplementary ingredient (26) is tahini and/or a sesame paste,
wherein the system (1) has a first supplementary ingredient container (48) in which the first supplementary ingredient (26) can be stored,
wherein the system (1) has a second supplementary ingredient container (49) in which a second supplementary ingredient (58) can be stored,
wherein the second supplementary ingredient (58) is a cooking oil,
wherein the system (1) has a third supplementary ingredient container (50) in which a third supplementary ingredient (60) can be stored,
wherein the third supplementary ingredient (60) is an acidifier,
wherein the first supplementary ingredient container (48) with a first ingredient pipe section (55), the second supplementary ingredient container (49) with a second ingredient pipe section (57) and the third supplementary ingredient container (50) with a third ingredient pipe section (59) are connected to the ingredient inlet section (25) of the mixing device (3), such that the supplementary ingredients (26, 58, 60) can be introduced into the mixing volume (23) by means of the ingredient pipe sections (55, 57, 5).

26. The system (1) according to claim 16, further comprising
a rinsing cleaning device (67), by which at least the vessel (2) and the mixing device (3) can be cleaned.

27. The system (1) according to claim 16, further comprising
a monitoring device (71),
wherein the monitoring device (71) has at least one sensor element (72) and at least one evaluation arrangement (73),
wherein the sensor element (72) and the evaluation arrangement (73) are adapted to one another and are brought into operative connection with at least one volume (5, 23, 31, 34, 45, 47, 52, 63) of the system (1) in such a way that it is possible to determine by means of the monitoring device (71) whether a proportion of inert gas within the at least one volume (5, 23, 31, 34, 45, 47, 52, 63) of the system (1) is sufficient to counteract spoilage of the food (40).

28. A method (74) for producing a pasty food (40), comprising:
using the system as in claim 23;
wherein the pasty food base (17) is first produced from the basic ingredient (13) in a reduction cooking process (75),
wherein the reduction cooking process (75) comprises a soaking step (78) and a cooking step (79) following the soaking step (78),
wherein the basic ingredient (13) is soaked in the soaking step (78) together with the water (14) while heat is applied by the temperature control arrangement (6),
wherein the basic ingredient (13) soaked in the soaking step (78) is processed into the pasty food base (17) in the cooking step (79) with the supply of heat by the temperature control arrangement (6) and with the supply of mechanical work by the vessel agitator (7),
wherein in a mixing process (76) following the reduction cooking process (75), the pasty food (40) is produced from the pasty food base (17) and the at least one supplementary ingredient by the mixing device (3), wherein the mixing process (76) has a pouring step (80) and a blending step (81) following the pouring step (80),
wherein in the pouring step (80) the pasty food base (17) and the at least one supplementary ingredient (26, 58, 60) are poured into the mixing volume (23), wherein in the blending step (81) the pasty food base (17) and the at least one supplementary ingredient (26, 58, 60) are blended together by the mixing agitator (24) such that the pasty food (40) is formed,
wherein the vessel volume (5) and the mixing volume (23) are filled or topped up with the inert gas in an inert gas introduction step (85) prior to the reduction cooking process (75) and are brought into operative connection with the inert gas source (28) during the reduction cooking process (75) and during the mixing process (76) in such a way that the food base (17) and the food (40) are prevented from coming into contact with oxygen and/or ambient air.

29. A method (74) for producing a pasty food (40), comprising:
using the system as in claim 21;
wherein the pasty food base (17) is first produced from the basic ingredient (13) in a reduction cooking process (75),
wherein the reduction cooking process (75) comprises a soaking step (78) and a cooking step (79) following the soaking step (78),
wherein the basic ingredient (13) is soaked in the soaking step (78) together with the water (14) while heat is applied by the temperature control arrangement (6),
wherein the basic ingredient (13) soaked in the soaking step (78) is processed into the pasty food base (17) in the cooking step (79) with the supply of heat by the temperature control arrangement (6) and with the supply of mechanical work by the vessel agitator (7),
wherein in a mixing process (76) following the reduction cooking process (75), the pasty food (40) is produced from the pasty food base (17) and the at least one supplementary ingredient by the mixing device (3), wherein the mixing process (76) has a pouring step (80) and a blending step (81) following the pouring step (80),
wherein in the pouring step (80) the pasty food base (17) and the at least one supplementary ingredient (26, 58, 60) are poured into the mixing volume (23), wherein in the blending step (81) the pasty food base (17) and the at least one supplementary ingredient (26, 58, 60) are blended together by the mixing agitator (24) such that the pasty food (40) is formed,
wherein the vessel volume (5) and the mixing volume (23) are filled or topped up with the inert gas in an inert gas introduction step (85) prior to the reduction cooking process (75) and are brought into operative connection with the inert gas source (28) during the reduction cooking process (75) and during the mixing process (76) in such a way that the food base (17) and the food (40) are prevented from coming into contact with oxygen and/or ambient air
wherein the mixing process (76) is followed by an intermediate storage step (82) in which the pasty food (40) is fed from the mixing device (3) into the storage container (32),
wherein the storage volume (34) is filled or topped up with the inert gas in the inert gas introduction step (85) and
wherein the storage container (32) is brought into operative connection with the inert gas source (28) during the intermediate storage step (82) in such a way that the food (40) is prevented from coming into contact with oxygen and/or the ambient air.

30. A method (74) for producing a pasty food (40), comprising:
using the system as in claim 22;
wherein the pasty food base (17) is first produced from the basic ingredient (13) in a reduction cooking process (75),
wherein the reduction cooking process (75) comprises a soaking step (78) and a cooking step (79) following the soaking step (78),
wherein the basic ingredient (13) is soaked in the soaking step (78) together with the water (14) while heat is applied by the temperature control arrangement (6),
wherein the basic ingredient (13) soaked in the soaking step (78) is processed into the pasty food base (17) in the cooking step (79) with the supply of heat by the temperature control arrangement (6) and with the supply of mechanical work by the vessel agitator (7),
wherein in a mixing process (76) following the reduction cooking process (75), the pasty food (40) is produced from the pasty food base (17) and the at least one supplementary ingredient by the mixing device (3), wherein the mixing process (76) has a pouring step (80) and a blending step (81) following the pouring step (80),
wherein in the pouring step (80) the pasty food base (17) and the at least one supplementary ingredient (26, 58, 60) are poured into the mixing volume (23), wherein in the blending step (81) the pasty food base (17) and the at least one supplementary ingredient (26, 58, 60) are blended together by the mixing agitator (24) such that the pasty food (40) is formed,
wherein the vessel volume (5) and the mixing volume (23) are filled or topped up with the inert gas in an inert gas introduction step (85) prior to the reduction cooking process (75) and are brought into operative connection with the inert gas source (28) during the reduction cooking process (75) and during the mixing process (76) in such a way that the food base (17) and the food (40) are prevented from coming into contact with oxygen and/or ambient air,
wherein the mixing process (76) is followed by a packaging process (77), in which the food (40) is packaged in the filling working volume (46) by the filling device (33),
wherein the packaging process (77) has a filling step (83) and a sealing step (84) following after the filling step (83),
wherein in the filling step (83) the food (40) is first fed from the mixing device (3) and/or the storage container (32) to the filling device (33),
wherein the food (40) is subsequently filled into the filling working volume (46) by the filling arrangement (42) of the filling device (33) within the filling working volume (45),
wherein the filled filling working volumes (46) are closed and sealed by the sealing arrangement (43) in the sealing step (84), which follows the filling process, wherein all working volumes of the filling device (33) are filled or topped up with the inert gas in the inert gas introduction step (85) and are brought at least indirectly into operative connection with the inert gas source (28) in such a way that the food (40) is filled without coming into contact with ambient air or oxygen.
